(19) United States
(12) Patent Application Publication
(10) Pub. No.: US 2026/0368020 A1
(43) Pub. Date: Nov. 19, 2026

(54) CXL DEVICE, METHOD OF OPERATION, AND COMPUTING SYSTEM USING THE SAME

(71) Applicant: SK hynix Inc., Icheon-si (KR)

(72) Inventors: Tae Ha KIM, Icheon-si (KR); Jee Yul KIM, Icheon-si (KR)

(21) Appl. No.: 19/374,550

(22) Filed: Oct. 30, 2025

(30) Foreign Application Priority Data
May 19, 2025 (KR) 10-2025-0064714

(51) Int. Cl. G06F 11/07; G06F 13/40

(52) U.S. Cl. CPC G06F 11/0787; G06F 11/0772; G06F 11/079; G06F 13/4068

(57) ABSTRACT

A compute express link (CXL) device may include a CXL memory, a management storage, and a CXL controller. The CXL controller may be electrically connected to an external device based on a CXL protocol, and configured to control the CXL memory and the management storage, and when an error is detected, store an error log in the CXL memory or the management storage based on a cause of the error.

### CROSS-REFERENCE TO RELATED APPLICATION

This application claims priority under 35 U.S.C. § 119(a) to Korean Patent Application No. 10-2025-0064714, filed in the Korean Intellectual Property Office on May 19, 2025, the entire contents of which are incorporated herein by reference.

### BACKGROUND

### 1. Technical Field

Various embodiments relate to electronic devices, and particularly, to a compute express link (CXL) device, a method of operating the CXL device, and a computing system using the CXL device.

### 2. Related Art

A compute express link (CXL) is an open standard interface for high-speed communication, and may provide a comprehensive interface environment that electrically connects a plurality of components such as a central processing unit (CPU), a memory, an accelerator, and other peripheral devices.

The CXL has an advantage of enabling flexible expansion of memory capacity. Accordingly, an environment capable of utilizing high computing resources and efficiently performing high-speed data processing may be reliably and easily configured through the CXL.

Electronic devices, such as CXL devices or computing systems using the CXL devices, may experience errors for various reasons.

A manufacturer of electronic devices needs to collect error logs in order to analyze and resolve the causes of errors occurring in the electronic devices.

### SUMMARY

In an embodiment, a compute express link (CXL) device may include: a CXL memory; a management storage; and a CXL controller electrically connected to an external device based on a CXL protocol, and configured to control the CXL memory and the management storage, and when an error is detected, store an error log in the CXL memory or the management storage based on a cause of the error.

In an embodiment, a method of operating a compute express link (CXL) device may include: detecting an error by a CXL controller in a CXL device, electrically connected to an external device based on a CXL protocol and including a CXL memory and a management storage that are controlled by the CXL controller; and storing, by the CXL controller, an error log in the CXL memory or the management storage based on a cause of the error.

In an embodiment, a computing system may include: at least one host electrically connected to a compute express link (CXL) switch; and at least one CXL device electrically connected to the CXL switch. The at least one CXL device may include: a CXL memory;
a management storage; and
a CXL controller electrically connected to the host based on a CXL protocol, and configured to control the CXL memory and the management storage and, when an error is detected, store an error log in the CXL memory or the management storage based on a cause of the error.

According to embodiments, errors occurring in a CXL device may be reliably collected, and corruption of system data during error log collection may be prevented.

### BRIEF DESCRIPTION OF THE DRAWINGS

FIG. 1 is a block diagram illustrating a configuration of a computing system according to an embodiment of the disclosure.

FIG. 2 is a block diagram illustrating a configuration of a compute express link (CXL) device according to an embodiment of the disclosure.

FIG. 3 is a block diagram illustrating a configuration of a CXL controller according to an embodiment of the disclosure.

FIG. 4 is a block diagram illustrating a configuration of an error log manager according to an embodiment of the disclosure.

FIG. 5 is a flowchart illustrating a method of operating a CXL device according to an embodiment of the disclosure.

### DETAILED DESCRIPTION

Hereinafter, embodiments will be described in detail with reference to the attached drawings.

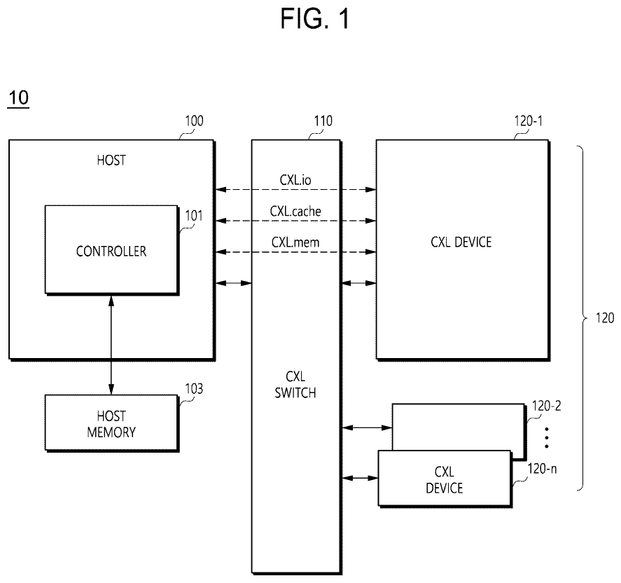

FIG. 1 is a block diagram illustrating a configuration of a computing system according to an embodiment of the disclosure.

Referring to FIG. 1, a computing system 10 may include at least one host 100, which is an external device, a compute express link (CXL) switch 110, and a plurality of CXL devices 120-1, 120-2, . . . , 120-n (collectively, CXL devices 120).

The host 100 and the CXL devices 120 may communicate with each other through the CXL switch 110. In other words, the CXL switch 110 may be configured to mediate communication between the host 100 and the CXL devices 120. For example, when the host 100 and the CXL devices 120 communicate with each other, the CXL switch 110 is configured to transmit and receive information such as a request, data, a response, or a signal to and from the host 100 and to and from the CXL devices 120.

The CXL switch 110 may implement a memory cluster using one-to-many or many-to-one switching among the connected CXL devices 120-1, 120-2, . . . , 120-n. The CXL devices 120-1, 120-2, . . . , 120-n may communicate with each other through the CXL switch 110, and in such cases, the CXL switch 110 may be configured to transmit and relay information such as a request, data, a response, or a signal between the CXL devices 120-1, 120-2, . . . , 120-n.

The at least one host 100 and the CXL devices 120 may communicate with each other through an interface that supports a plurality of sub-protocols defined in a CXL protocol. Messages and/or data may be transmitted between the at least one host 100 and the plurality of CXL devices 120 through the plurality of sub-protocols. For example, the sub-protocols include a non-coherent protocol (also referred to as an I/O protocol; IO) CXL.io, a coherent protocol (also referred to as a cache protocol; CACHE) CXL.cache, and a memory access protocol (also referred to as a memory protocol; MEM) CXL.mem.

The I/O protocol CXL.io may be an input/output protocol similar to peripheral component interconnect express (PCIe), and may perform operations such as device discovery, connection, initial setup, and access to virtualization registers. In an embodiment, the I/O protocol CXL.io provides a non-coherent load/store interface.

The cache protocol CXL.cache may be a protocol used to allow the CXL devices 120 to access a host memory 103 and to implement cache coherency with the host memory 103. In an embodiment, the cache protocol CXL.cache includes three channels including a request, a response, and data.

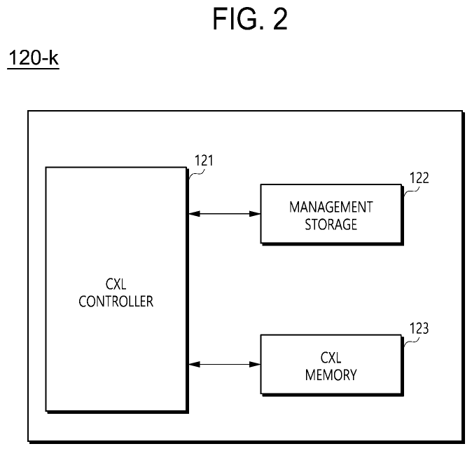

The memory protocol CXL.mem may be a protocol used when the host 100 accesses a CXL memory 123 (see FIG. 2) provided in the CXL device 120.

Embodiments are not limited to the above description, and the CXL devices 120-1, 120-2, . . . , 120-n may communicate with the host 100 using any type of storage interface and/or protocol, such as peripheral component interconnect express (PCIe), non-volatile memory express (NVMe), NVMe-over-fabric (NVMe-oF), NVMe key-value (NVMe-KV), serial advanced technology attachment (SATA), or small computer system interface (SCSI).

The host 100 may include a controller 101 and the host memory 103. The controller 101 may include at least one processor configured to control overall operations of the host 100. The host memory 103 may be provided inside or outside the host 100.

The controller 101 enables the host 100 to communicate with the CXL devices 120 through the CXL switch 110, and may control operations of the host memory 103. The host memory 103 may write or read data under the control of the controller 101.

FIG. 2 is a block diagram illustrating a configuration of a CXL device according to an embodiment of the disclosure.

In FIG. 2, an exemplary CXL device 120-k of the CXL devices 120 in FIG. 1 is illustrated. Any one CXL device 120-k may include a CXL controller 121, a management storage 122, and a CXL memory 123.

The CXL controller 121 may be electrically connected to the CXL switch 110. The CXL controller 121 may communicate with at least one host 100 and/or other CXL devices through the CXL switch 110. The CXL controller 121 may include a PCIe architecture for a CXL.io path, and may include paths for CXL-specific protocols such as CXL.cache and CXL.mem.

The CXL controller 121 may be configured to control the management storage 122 and the CXL memory 123. In an embodiment, the CXL controller 121 maps a logical address received from the host 100 to a physical address of the CXL memory 123. In an embodiment, the CXL controller 121 stores data received from the host 100 in the CXL memory 123, or reads data stored in the CXL memory 123. In an embodiment, the CXL controller 121 is implemented to comply with standard protocols such as a double data rate (DDR) interface or a low-power double data rate (LPDDR) interface.

The management storage 122 may store boot code, firmware, and the like necessary for operation of the CXL device 120-k. In particular, according to an embodiment, the management storage 122 under the control of the CXL controller 121 may store error logs.

In an embodiment, the management storage 122 is a non-volatile serial peripheral interface (SPI) memory device. The SPI memory device may include a NOR flash memory device.

Under the control of the CXL controller 121, the CXL memory 123 may store data or read stored data. The CXL memory 123 may perform computation on the stored data, and may store a result of the computation in the CXL memory 123 or provide the result to the CXL controller 121.

The CXL memory 123 may include a volatile memory device such as a dynamic random access memory (DRAM), and may include a non-volatile memory device such as a flash memory device.

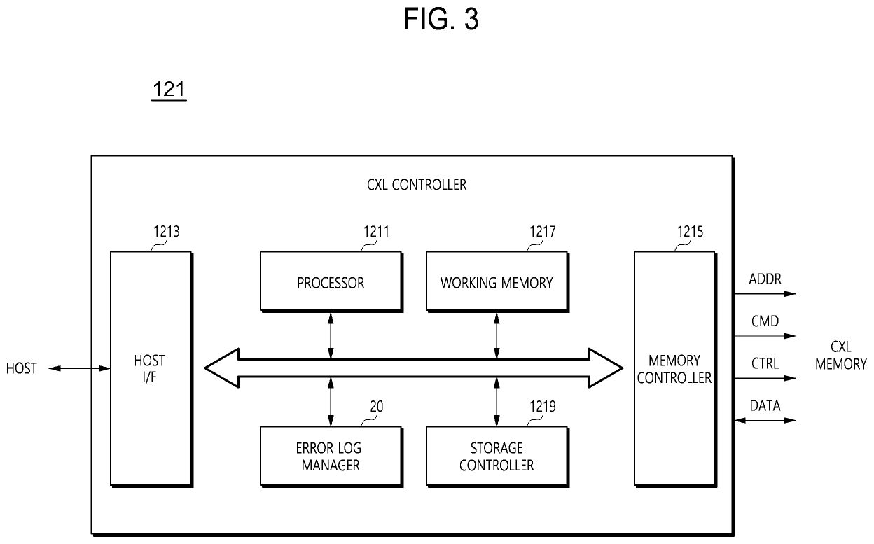

FIG. 3 is a block diagram illustrating a configuration of a CXL controller according to an embodiment of the disclosure.

As illustrated in FIG. 3, a CXL controller 121 may include a processor 1211, a host interface (IF) 1213, a memory controller 1215, a working memory 1217, a storage controller 1219, and an error log manager 20.

The CXL controller 121 may interpret a request from the host 100 and may transmit an address ADDR, a command CMD, and a control signal CTRL to the CXL memory 123, and may transmit and receive data DATA to and from the CXL memory 123.

The processor 1211 may control overall operations of the CXL controller 121.

The processor 1211 may be configured to execute firmware or software provided for various operations of the CXL controller 121 on hardware, thereby enabling the operations of the CXL controller 121 to be performed. The processor 1211 may be implemented in a form in which the hardware and the firmware or software operating on the hardware are combined.

The processor 1211 may control the CXL controller 121 by executing firmware loaded on the working memory 1217. In an embodiment, the processor 1211 includes a central processing unit (CPU), a controller, an application specific integrated circuit (ASIC), or the like.

The host IF 1213 may provide a communication channel configured to receive a command from the host 100 and control input and output of data under the control of the processor 1211. In particular, the host IF 1213 may provide physical connection between the host 100 and the CXL device 120. The host interface 1213 may communicate with the host 100 based on at least a CXL interface protocol.

The memory controller 1215 may provide a communication channel configured to transmit and receive signals and data between the CXL controller 121 and the CXL memory 123. The memory controller 1215 may be configured to control access operations to the CXL memory 123 under the control of the processor 1211. The access operations to the CXL memory 123 may include, for example, read, write, and erase operations. In an embodiment, the memory controller 1215 controls the CXL memory 123 so that data transmitted from the host 100 is stored in the CXL memory 123 under the control of the processor 1211. The memory controller 1215 enables data read from the CXL memory 123 to be transmitted to the host 100 under the control of the processor 1211.

The working memory 1217 may store code data needed to boot the CXL device 120, firmware that is executed by the processor 1211, and metadata required for execution of the firmware. The working memory 1217 may store instructions and data that are executed and processed by the CXL controller 121. In an embodiment, the working memory 1217 may be implemented using a volatile memory such as a DRAM or a static random access memory (SRAM), but embodiments are not limited thereto.

Although FIG. 3 illustrates a working memory 1217 that is provided inside the CXL controller 121, embodiments are not limited thereto, and the working memory 1217 may be provided outside the CXL controller 121.

The storage controller 1219 may control the management storage 122 under the control of the processor 1211. The management storage 122 may store boot code provided to start the CXL device 120 and firmware provided to operate the CXL controller 121.

When an error occurs in the CXL device 120, the error log manager 20 may determine a storage location of an error log based on a cause of error detection and store the error log.

In an embodiment, when an error is detected in a signal path associated with the CXL memory 123, the error log manager 20 stores an error log in the management storage 122.

In an embodiment, when an error is detected due to a cause other than the signal path associated with the CXL memory 123, for example, in firmware, the working memory 1217, or the management storage 122, the error log manager 20 stores an error log in the CXL memory 123.

The error log manager 20 may store verification data, such as parity data or a hash value, together with an error log when storing the error log, in order to manage the modification or corruption of the error log. Subsequently, the error log and the verification data may be read from the CXL device 120, and the validity of the error log may be verified using the verification data, thereby ensuring the reliability of the error log.

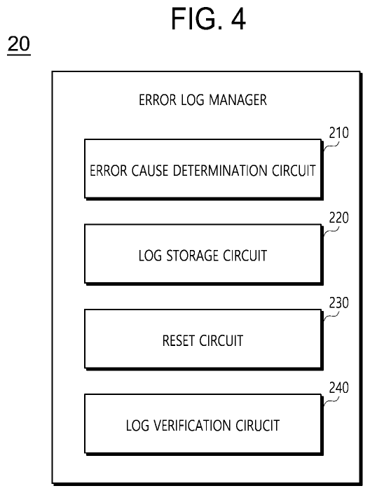

FIG. 4 is a block diagram illustrating a configuration of the error log manager according to an embodiment of the disclosure.

Referring to FIG. 4, an error log manager 20 may include an error cause determination circuit 210, a log storage circuit 220, a reset circuit 230, and a log verification circuit 240.

When an error occurs in the CXL device 120, the error cause determination circuit 210 may receive an interrupt related to error detection from the CXL controller 121 and determine a cause of the error. The error of the CXL device 120 may be a hardware error or a software error. The error cause determination circuit 210 may determine whether the detected error is a hardware error or a software error, whether the error is related to the CXL memory 123 or a signal path associated with the CXL memory 123, or whether the error is related to the management storage 122 or a signal path associated with the management storage 122.

The log storage circuit 220 may determine a storage location of an error log based on a cause of the detected error, and store the error log.

In an embodiment, when an error is detected in the signal path associated with the CXL memory 123, the log storage circuit 220 stores the error log in the management storage 122.

In an embodiment, when an error is detected due to a cause other than a signal path associated with the CXL memory 123, for example, in firmware, the working memory 1217, the management storage 122, or a signal path associated with the management storage 122, the log storage circuit 220 stores the error log in the CXL memory 123.

The log storage circuit 220 may generate verification data, such as parity data or a hash value, for the error log when storing the error log, and store the verification data together with the error log.

Upon the storage of the error log, the reset circuit 230 may reset components other than the CXL memory 123, for example, the CXL controller 121 and the management storage 122.

The log verification circuit 240 may read the error log and the verification data from the CXL memory 123 as the CXL device 120 is reset. The log verification circuit 240 may verify the validity of the error log based on the verification data, and store the valid error log in the management storage 122.

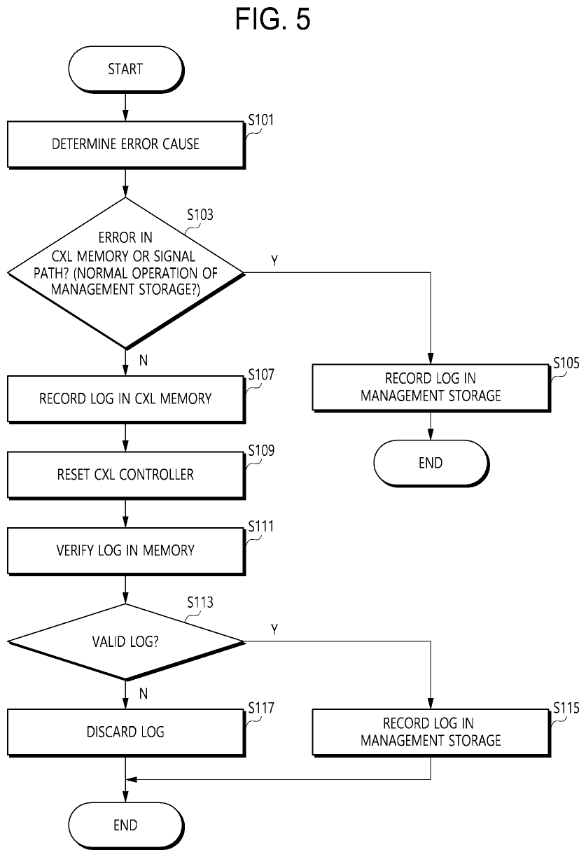

FIG. 5 is a flowchart illustrating a method of operating a CXL device according to an embodiment of the disclosure.

Referring to FIG. 5, when an error occurs in CXL devices 120, a CXL controller 121 including an error log manager 20 may receive an interrupt related to error detection and determine a cause of the error (in operation S101).

The CXL controller 121 may determine whether the detected error is a hardware error or a software error, whether the detected error has occurred in the CXL memory 123 or the signal path associated with the CXL memory 123, or whether the detected error has occurred in the management storage 122 or the signal path associated with the management storage 122.

In an embodiment, the CXL controller 121 determines whether the management storage 122 is operating normally an error is detected in the CXL memory 123 or in the signal path associated with the CXL memory 123 (in operation S103).

When an error is detected in the CXL memory 123 or in the signal path associated with the CXL memory 123 (in operation S103: Y), the CXL controller 121 may store an error log in the management storage 122 (in operation S105).

When no error is detected in the CXL memory 123 or in the signal path associated with the CXL memory 123 (in operation S103: N), and in another aspect, when an error is detected in, for example, the firmware, the working memory 1217, the management storage 122, or the signal path associated with the management storage 122, the CXL controller 121 may store an error log in the CXL memory 123 (in operation S107).

When storing an error log (in operation S105 or S107), the CXL controller 121 may generate verification data, such as parity data or a hash value, for the error log and store the verification data together with the error log.

Upon storage of the error log, the CXL controller 121 may reset components other than the CXL memory 123, such as for example the CXL controller 121 and the management storage 122 (in operation S109).

After the CXL device 120 is reset, the CXL controller 121 may read the error log and the verification data from the CXL memory 123 and verify the validity of the error log (in operation S111).

The CXL controller 121 may determine whether the error log is valid (in operation S113), and in the case where the error log is determined to be valid (in operation S113: Y), may store the error log in the management storage 122 (in operation S115).

In the case where the error log is determined to be invalid (in operation S113: N), the CXL controller 121 may discard the error log read from the CXL memory 123 (in operation S117).

After detecting the error and storing the error log, the CXL controller 121 may respond to a request from a host 100 with poison (or corrupted) data until the CXL device 120 is reset. The host 100 may receive poison data from the CXL device 120 in which the error has occurred, recognize an error condition of the CXL device 120, and prevent the error from propagating to other devices of the computing system 10.

In a viral situation in which a critical error such as a firmware bug, defect, or file system corruption occurs in the CXL device 120, attempting to store an error log in the management storage 122 may cause important system data, such as firmware or system configuration information, to be corrupted.

In an embodiment, all requests from the host 100 may be responded to with poison data in a viral situation, and an error log may be stored in the CXL memory 123. In addition, after the CXL controller 121 is reset, a valid error log read from the CXL memory 123 may be reliably stored in the management storage 122 and utilized for debugging.

As described above, those skilled in the art to which the present technology pertains may understand that the present technology may be implemented in various other forms without departing from the technical spirit or essential characteristics of the present technology. Accordingly, it is to be understood that the aforementioned embodiments are illustrative from all aspects not being limitative. The scope of the present technology is defined by the appended claims rather than by the detailed description, and all modifications or variations derived from the meanings and scope of the claims and equivalents thereof should be understood as being included in the scope of the present technology.

What is claimed is:

1. A compute express link (CXL) device comprising:
a CXL memory;
a management storage; and
a CXL controller electrically connected to an external device based on a CXL protocol, and configured to control the CXL memory and the management storage, and when an error is detected, store an error log in the CXL memory or the management storage based on a cause of the error.

2. The CXL device of claim 1, wherein the CXL controller is configured to store the error log in the CXL memory when the cause of the error is determined to be a cause other than the CXL memory or a signal path associated with the CXL memory.

3. The CXL device of claim 2, wherein the CXL controller is configured to reset the CXL controller and the management storage, read the error log from the CXL memory, and store the error log in the management storage.

4. The CXL device of claim 2, wherein the CXL controller is configured to further store verification data for the error log in the CXL memory.

5. The CXL device of claim 4, wherein the CXL controller is configured to reset the CXL controller and the management storage, read the error log from the CXL memory, verify validity of the error log based on the verification data, and store the error log that is valid in the management storage.

6. The CXL device of claim 1, wherein the CXL controller is configured to transmit poison data in response to a request from the external device when the error is detected.

7. The CXL device of claim 1, wherein the management storage comprises a non-volatile serial peripheral interface (SPI) memory device.

8. A method of operating a compute express link (CXL) device comprising:
detecting an error by a CXL controller in a CXL device, electrically connected to an external device based on a CXL protocol and including a CXL memory and a management storage that are controlled by the CXL controller; and
storing, by the CXL controller, an error log in the CXL memory or the management storage based on a cause of the error.

9. The method of claim 8, wherein the storing of the error log comprises storing, by the CXL controller, the error log in the CXL memory when the cause of the error is determined to be a cause other than the CXL memory or a signal path associated with the CXL memory.

10. The method of claim 9, further comprising:
resetting, by the CXL controller, the CXL controller and the management storage after the error log is stored in the CXL memory; and
reading the error log from the CXL memory, and storing the error log in the management storage.

11. The method of claim 9, further comprising storing, by the CXL controller, verification data for the error log in the CXL memory.

12. The method of claim 11, further comprising:
resetting, by the CXL controller, the CXL controller and the management storage after the error log and the verification data are stored in the CXL memory;
reading, by the CXL controller, the error log from the CXL memory;
verifying, by the CXL controller, validity of the error log based on the verification data; and
storing, by the CXL controller, the error log that is valid in the management storage.

13. The method of claim 8, further comprising transmitting, by the CXL controller, poison data in response to a request of the external device when the error is detected.

14. A computing system comprising:
at least one host electrically connected to a compute express link (CXL) switch; and
at least one CXL device electrically connected to the CXL switch,
wherein each of the at least one CXL device comprises:
a CXL memory;
a management storage; and
a CXL controller electrically connected to the host based on a CXL protocol, and configured to control the CXL memory and the management storage and, when an error is detected, store an error log in the CXL memory or the management storage based on a cause of the error.

15. The computing system of claim 14, wherein the CXL controller i configured to store the error log in the CXL memory when the cause of the error is determined to be a cause other than the CXL memory or a signal path associated with the CXL memory.

16. The computing system of claim 15, wherein the CXL controller i configured to further store verification data for the error log in the CXL memory.

17. The computing system of claim 16, wherein the CXL controller i configured to, after the error log and the verification data are stored, reset the CXL controller and the management storage, read the error log from the CXL memory, verify validity of the error log based on the verification data, and store the error log that is valid in the management storage.

18. The computing system of claim 14, wherein the CXL controller i configured to transmit poison data in response to a request from the host when the error is detected.

19. The computing system of claim 14, wherein the CXL memory comprises a dynamic random access memory (DRAM).

20. The computing system of claim 14, wherein the management storage comprises a non-volatile serial peripheral interface (SPI) memory device.
